(19) United States
(12) Patent Application Publication
(10) Pub. No.: US 2025/0368075 A1
(43) Pub. Date: Dec. 4, 2025

(54) Automatic Power Negotiation Between Vehicle-To-Vehicle (V2V) Power Transfer

(71) Applicant: Flex Ltd., Singapore (SG)

(72) Inventors: Wei Lung LU, New Taipei City (TW); Chen Hui WU, New Taipei City (TW); Peter CHIA, New Taipei City (TW); Po Hung LIN, New Taipei City (TW); Shih Chieh HUANG, New Taipei City (TW)

(73) Assignee: Flex Ltd., Singapore (SG)

(21) Appl. No.: 18/676,136

(22) Filed: May 28, 2024

(51) Int. Cl. B60L 53/62; B60L 53/18; B60L 53/53; B60L 53/66

(52) U.S. Cl. CPC B60L 53/62; B60L 53/18; B60L 53/53; B60L 53/66

(57) ABSTRACT

A method for automatic power negotiation for electric vehicle-to-vehicle charge transfer, includes connecting a donor electric vehicle to a receiver electric vehicle via a charging cable of a charging cable system and receiving from a control box of the charging cable system, an initial power setting for the donor electric vehicle. The method also includes determining if the initial power setting has a non-zero value and if the initial power setting has a non-zero value, determining if the initial power setting is acceptable by the donor electric vehicle. The method further includes if the initial power setting is acceptable by the donor electric vehicle, repeatedly increasing the initial power setting to a higher power setting until a maximum power setting is determined and transferring an electric charge from the donor electric vehicle to the receiver electric vehicle along the charging cable based on the maximum power setting.

### FIELD

The present disclosure is related generally to the field of electric vehicles, and more specifically to methods, systems, and devices for charging between electric vehicles.

### BACKGROUND

Conventionally, electric vehicles (e.g., battery powered vehicles) are charged in a manner similar to those used to charge most rechargeable battery powered devices. That is, the operator plugs a charger for the vehicle's battery into an electrical outlet connected to a utility's electric power grid (the “grid”) and the vehicle's charger immediately begins charging the vehicle's battery.

Due to the lack of widespread electric-charging infrastructure (e.g., electric vehicle charging stations), electric vehicle-to-vehicle (V2V) charging has been developed. Therefore, if an electric vehicle nears the end of its battery charge (e.g., a receiver vehicle), another electric vehicle (e.g., a donor vehicle) may be able to assist the receiver vehicle that is running out of charge in the event that a charging station is unavailable or inconveniently located. Charging between the two electric vehicles may be difficult due to compatibility issues between the various makers and models of electric vehicles. Hence, there is a need for improved methods, systems and devices for charging between electric vehicles that are simple and convenient and eliminate incompatibility issues.

### BRIEF DESCRIPTION OF THE DRAWINGS

FIG. 1 is an example block diagram of a conventional configuration of an electric vehicle-to-vehicle (V2V) charging system;

FIG. 2a is an example block diagram of a conventional configuration of an electric V2V charging system;

FIG. 2b is an example block diagram of an automatic power negotiation electric V2V charging system in accordance with embodiments of the present disclosure;

FIG. 3 is an example schematic block diagram of an automatic power negotiation electric V2V charging system in accordance with embodiments of the present disclosure;

FIG. 4 is a diagram of an example automatic power negotiation electric V2V charging device in accordance with embodiments of the present disclosure;

FIG. 5 is an example table of a donor control pilot frequency and tolerance summary for electric V2V charging;

FIG. 6 is an example table of control pilot states for electric V2V charging;

FIG. 7 is a diagram illustrating an example donor control pilot state machine for automatic power negotiation electric V2V charging in accordance with embodiments of the present disclosure;

FIG. 8 is an example power level table for an automatic power negotiation electric V2V charging system in accordance with embodiments of the present disclosure;

FIGS. 9a and 9b illustrate a flowchart of an example method for automatic power negotiation for electric V2V charging in accordance with embodiments of the present disclosure;

FIG. 10 is a diagram of an example computer-readable data storage medium; and

FIG. 11 is a diagram of an example system that is consistent with but more general than the system of FIG. 3.

### DETAILED DESCRIPTION

Embodiments of the present disclosure are directed to an electric vehicle-to-vehicle (V2V ) charging cable capable of automatic power negotiation between two electric vehicles.

Embodiments of the present disclosure include a method for automatic power negotiation for electric vehicle-to-vehicle charge transfer including connecting a donor electric vehicle to a receiver electric vehicle via a charging cable of a charging cable system, receiving from a control box of the charging cable system, an initial power setting for the donor electric vehicle and determining if the initial power setting has a non-zero value. If the initial power setting has a non-zero value, determining if the initial power setting is acceptable by the donor electric vehicle and if the initial power setting is acceptable by the donor electric vehicle, repeatedly increasing the initial power setting to a higher power setting until a maximum power setting is determined. The method also includes transferring an electric charge from the donor electric vehicle to the receiver electric vehicle along the charging cable based on the maximum power setting.

Aspects of the above method include wherein the donor electric vehicle is configured to transmit to the receiver electric vehicle, via the charging cable, an indication of the maximum power setting.

Aspects of the above method include wherein if the initial power setting is not acceptable by the donor electric vehicle, assigning the initial power setting as the maximum power setting.

Aspects of the above method further include storing the maximum power setting in the control box.

Aspects of the above method include wherein if the initial power setting is determined not to have a non-zero value, determining a power setting using a binary search.

Aspects of the above method further include determining if the power setting determined using the binary search is acceptable by the donor electric vehicle, if the power setting determined using the binary search is acceptable by the donor electric vehicle, repeatedly increasing the power setting determined using the binary search to a higher power setting until the maximum power setting is determined and transferring the electric charge from the donor electric vehicle to the receiver electric vehicle along the charging cable based on the maximum power setting.

Aspects of the above method include wherein repeatedly increasing the initial power setting to a higher power setting includes increasing a current value and keeping a voltage value constant, increasing the current value and increasing the voltage value, increasing the voltage value and keeping the current value constant, increasing the voltage value and increasing the current value or increasing the voltage value and decreasing the current value.

Aspects of the above method include wherein the charging cable system includes electric vehicle supply equipment (EVSE) connectors to connect the donor electric vehicle to the receiver electric vehicle.

Embodiments of the present disclosure include a system for automatic power negotiation for electric vehicle-to-vehicle charge transfer including a charging cable configured to connect a donor electric vehicle to a receiver electric vehicle and a control box. The control box is configured to retrieve an initial power setting for the donor electric vehicle, determine if the initial power setting has a non-zero value, if the initial power setting has a non-zero value, determine if the initial power setting is acceptable by the donor electric vehicle, if the initial power setting is acceptable by the donor electric vehicle, repeatedly increase the initial power setting to a higher power setting until a maximum power setting is determined and transfer an electric charge from the donor electric vehicle to the receiver electric vehicle along the charging cable based on the maximum power setting.

Aspects of the above system include wherein the donor electric vehicle is configured to transmit to the receiver electric vehicle, via the charging cable, an indication of the maximum power setting.

Aspects of the above system include wherein if the initial power setting is not acceptable by the donor electric vehicle, the control box is further configured to assign the initial power setting as the maximum power setting.

Aspects of the above system include wherein the control box is further configured to store the maximum power setting in the control box.

Aspects of the above system include wherein if the initial power setting is determined not to have a non-zero value, the control box is further configured to determine a power setting using a binary search.

Aspects of the above system include wherein the control box is further configured to determine if the power setting determined using the binary search is acceptable by the donor electric vehicle, if the power setting determined using the binary search is acceptable by the donor electric vehicle, repeatedly increase the power setting determined using the binary search to a higher power setting until the maximum power setting is determined and transfer the electric charge from the donor electric vehicle to the receiver electric vehicle along the charging cable based on the maximum power setting.

Aspects of the above system include wherein repeatedly increase the initial power setting to a higher power setting includes increases a current value and keep a voltage value constant, increase the current value and increase the voltage value, increase the voltage value and keep the current value constant, increase the voltage value and increase the current value or increase the voltage value and decrease the current value.

Aspects of the above system include wherein the charging cable includes electric vehicle supply equipment (EVSE) connectors for connecting the donor electric vehicle and the receiver electric vehicle.

Embodiments of the present disclosure include a control box including one or more processors configured to retrieve an initial power setting for a donor electric vehicle, determine if the initial power setting has a non-zero value, if the initial power setting has a non-zero value, determine if the initial power setting is acceptable by the donor electric vehicle, if the initial power setting is acceptable by the donor electric vehicle, repeatedly increase the initial power setting to a higher power setting until a maximum power setting is determined and transfer an electric charge from the donor electric vehicle to a receiver electric vehicle along a charging cable connecting the donor electric vehicle and the receiver electric vehicle based on the maximum power setting.

Aspects of the above control box include wherein if the initial power setting is determined not to have a non-zero value, the control box is further configured to determine a power setting using a binary search.

Aspects of the above control box include wherein the control box is further configured to determine if the power setting determined using the binary search is acceptable by the donor electric vehicle, if the power setting determined using the binary search is acceptable by the donor electric vehicle, repeatedly increase the power setting determined using the binary search to a higher power setting until the maximum power setting is determined and transfer the electric charge from the donor electric vehicle to the receiver electric vehicle along the charging cable based on the maximum power setting.

Aspects of the above control box include wherein repeatedly increase the initial power setting to a higher power setting includes increases a current value and keep a voltage value constant, increase the current value and increase the voltage value, increase the voltage value and keep the current value constant, increase the voltage value and increase the current value or increase the voltage value and decrease the current value.

The subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the subject matter may be practiced without these specific details. In other instances, well-known structures and devices are shown in block diagram form in order to facilitate describing the subject innovation.

Moreover, the word “exemplary” is used herein to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. In addition, the word “coupled” is used herein to mean direct or indirect electrical or mechanical coupling.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, CPU, GPU, DSP, FPGA, integrated circuit, ASIC, etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

The terms “donor,” “donation,” “donator,” and “donating vehicle” are used to describe the action or the vehicle that transfers an electric charge to another vehicle. The root term “donate” is used in this context to more clearly specify the relationship between the two vehicles. The terms “receive,” acceptor,” and “receiving vehicle” are used to describe the action or the vehicle that receives an electric charge from another vehicle.

The term “electric vehicle” as used herein refers to a vehicle that uses one or more electric motors for propulsion, the one or more electric motors relying at least in part on electric current from a battery.

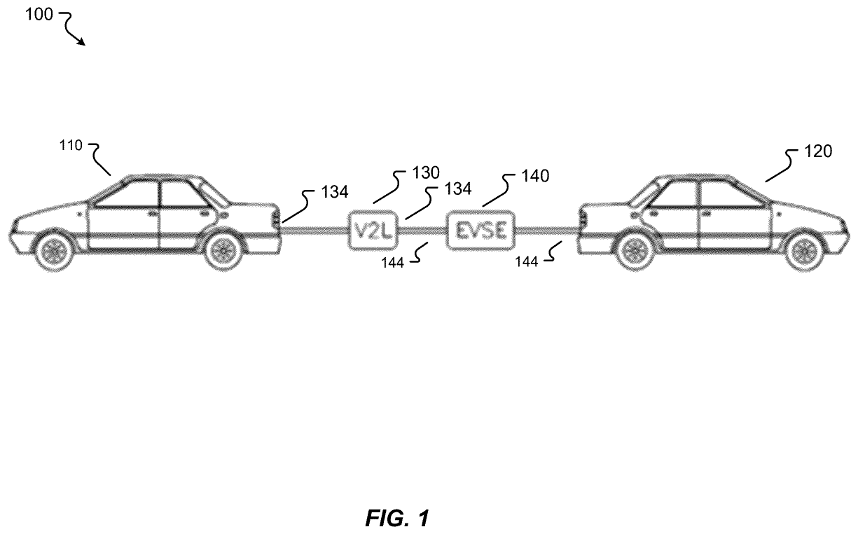

FIG. 1 is an example block diagram of a conventional configuration of an electric vehicle-to-vehicle (V2V ) charging system 100. The conventional electric V2V charging system 100 generally includes a donor electric vehicle 110, a receiver electric vehicle 120, a vehicle-to-load (V2L) charging device 130 including cables 134 and electric vehicle supply equipment (EVSE) device 140 including cables 144. EVSE refers to the infrastructure used to charge electric vehicles. EVSE encompasses charging stations, connectors, cables, and any associated hardware or software used to facilitate the charging process. EVSE can vary in complexity and features. As illustrated in FIG. 1, the EVSE device 140 refers to control devices, connectors and cables coupled with the donor electric vehicle 110 and/or the receiver electric vehicle 120.

V2L charging device 130 provides V2L technology that enables electric vehicles to serve as a power source and allows the vehicle serving as the power source to discharge energy stored in their batteries to power external devices or even supply electricity back to the power grid. The V2L technology typically requires specialized cables such as cables 144 and interfaces to connect the electric vehicle's battery to external devices or electrical systems. Cables such as cables 134 and 144 are designed to handle electric power safely and efficiently, typically incorporating features such as insulation, shielding and connectors compatible with both the vehicle and the external device or system.

The conventional electric V2V charging system 100 couples the V2L charging device 130 and the EVSE device 140 in series using the cables 134 and 144 along with the various connectors and interfaces to perform electric V2V charging. The EVSE device 140 typically includes ground monitoring interruption (GMI) protection and has a fixed maximum power level. GMI protection is a system that performs a few tests to ensure an entire circuit is grounded before letting the current flow. This feature ensures that the electrical panel, charger, and vehicle are properly grounded at all times. On the one hand, the V2L charging device 130 usually outputs power at a fixed level. The integration of the EVSE device 140 and the V2L charging device 130 may result in an unintended operation. This is especially true when a maximum operation current of the EVSE device 140 is higher than an operating current of the V2L charging device 130.

Another challenge with the conventional V2V charging system 100 is the potential underutilization between the capabilities of the EVSE device 140 and the V2L charging device 130. The fixed power levels from both components may not align with the specific power requirements or capabilities of individual electric vehicle (e.g., donor electric vehicle 110 and receiver electric vehicle 120). This mismatch can result in inefficient charging or incompatibility issues where some electric vehicles may not receive the optimal electric charge they can handle, while other electric vehicles may receive more electric charge than needed. For the latter, this may potentially cause over-current protection being employed leading to the inability to properly charge the receiver electric vehicle 120.

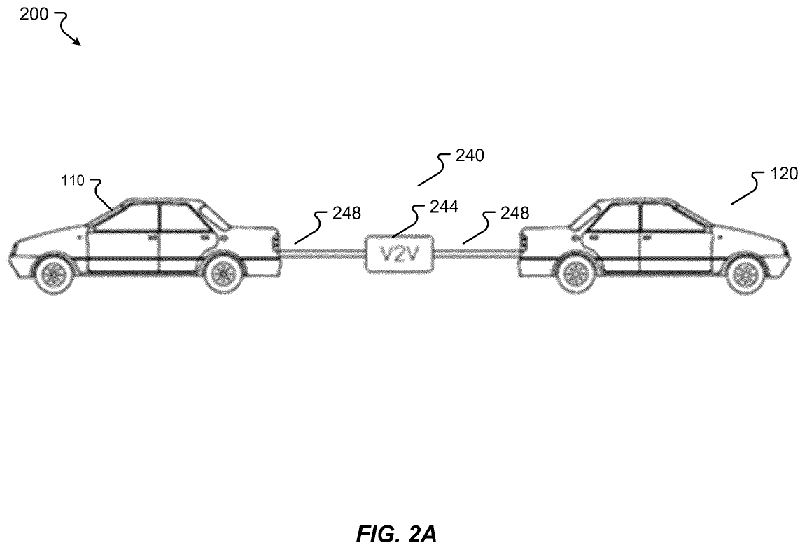

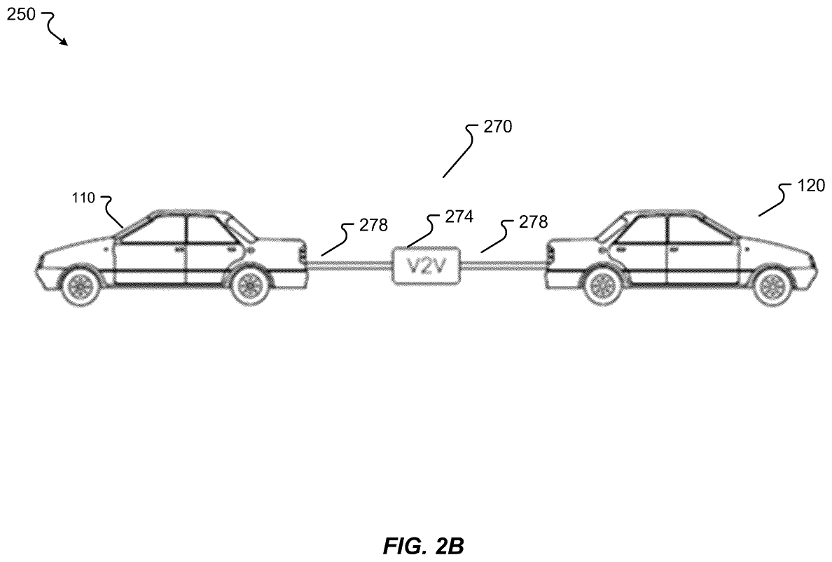

FIG. 2a is an example block diagram of a conventional configuration of an electric V2V charging system 200. The electric V2V charging system 200 generally includes a donor electric vehicle 110, a receiver electric vehicle 120 and an electric V2V charging cable 240. The electric V2V charging cable 240 includes a cable control unit 244 and cables 248. The electric V2V charging system 200 is associated with Stellantis which is a multinational automotive manufacturing corporation formed from the merger in 2021 of the Italian American conglomerate Fiat Chrysler Automobiles and the French Peugeot S.A. Group. The cable control unit 244 has the advantage of achieving a V2V charging function and generates a 166 Hz with a 53.3% duty cycle pulse width modulation (PWM) frequency signal through a donor control pilot to negotiate with the donor electric vehicle 110. If the donor electric vehicle 110 accepts this request, then the cable control unit 244 further generates a 1 KHz with the 53.3% duty cycle (PWM) frequency signal through the receiver control pilot of the receiver electric vehicle 120 for power transfer. The power requests for the donor vehicle 110 are fixed voltages and fixed currents, (e.g., 240 alternating current voltage (VAC) and 32 amperes (A), respectively). The conventional cable control unit 244 can only be used with the capability of a 32 A integrated dual charging module (IDCM). In other words, the conventional V2V charging cable 240 only has fixed output voltages, specific currents, and fixed power ratings. For example, if the donor electric vehicle 110′s IDCM rating current is 120 VAC at 16A and the conventional V2V is needed for 240 VAC at 32 A, the convention V2V charging cable 240 will not work because the demand cannot match.

The conventional electric V2V charging systems, however, are not provided with automatic power negotiation which solves mismatch issues and brings convenience for electric vehicles during charging applications. In other words, automatic power negotiation can automatically scale down for the selection of an output voltage and power rating to meet various power specifications for changing situations.

FIG. 2b is an example block diagram of an automatic power negotiation electric V2V charging system 250 in accordance with embodiments of the present disclosure. The automatic power negotiation electric V2V charging system 250 generally includes a donor electric vehicle 110, a receiver electric vehicle 120 and an automatic power negotiation electric V2V charging device 270. The automatic power negotiation electric V2V charging device 270 includes a control box 274 and cables 278. According to embodiments of the present disclosure, automatic power negotiation will determine the maximum power level available from the donor electric vehicle 110. Instead of a fixed power level of a rated cable, according to embodiments of the present disclosure, a single cable solution covers all power ranges and can handle low powered vehicles. According to embodiments of the present disclosure, the incompatibility issues between different EVSE and V2L charging devices are eliminated.

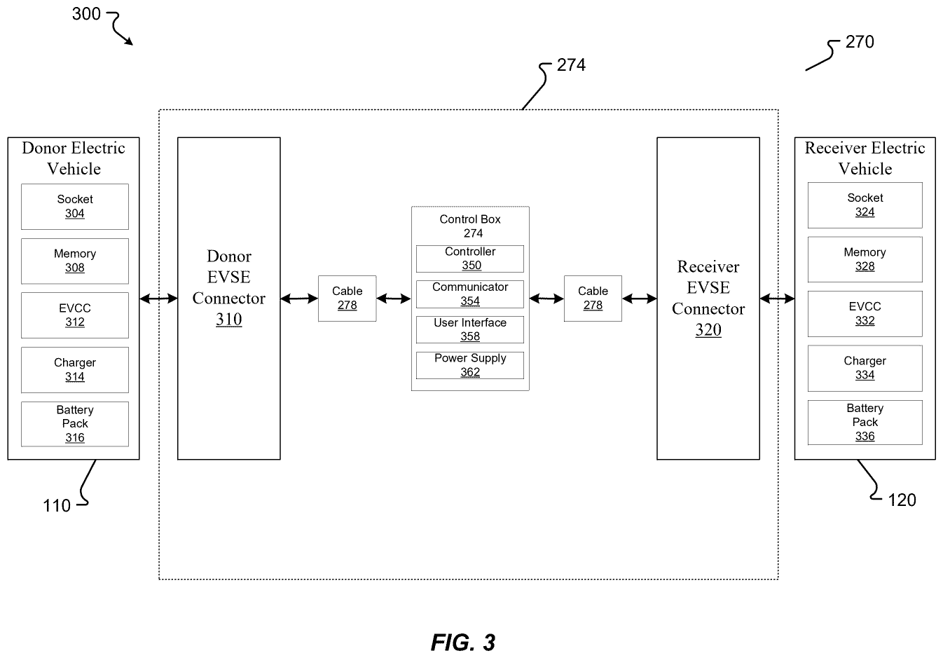

FIG. 3 is an example schematic diagram of an automatic power negotiation electric V2V charging system 300 in accordance with embodiments of the present disclosure. The automatic power negotiation electric V2V charging system 300 generally includes a donor electric vehicle 110, a receiver electric vehicle 120 and an automatic power negotiation electric V2V charging device 270. The automatic power negotiation electric V2V charging device 270 includes a control box 274 and cables 278. The donor electric vehicle generally includes a socket 304, a memory 308, an electric vehicle communication controller (EVCC) 312, a battery charger 314 and a battery pack 316. Likewise, the receiver electric vehicle 120 includes a socket 324, a memory 338, an EVCC 332, a battery charger 334 and a battery pack 336. The memory 308 and the memory 328 are components typically found in an electric vehicle and store data regarding the electric vehicle. The EVCC 312 controls the battery charger 314 and the battery pack 316, while the EVCC 332 controls the battery charger 334 and the battery pack 336.

The donor electric vehicle 110 supports V2L functionality described in the Society of Automotive Engineers (SAE) J2847/5 standard, which allows the donor electric vehicle 110 to supply electrical power to the receiver electric vehicle 120. The SAE J2847/5 standard specifically focuses on bidirectional energy transfer between electric vehicles and the grid, as well as between electric vehicles themselves. This standard gets guidelines and protocols for V2L functionality ensuring interoperability and safety. The V2L functionality that is based on the SAE J2847/5 standard addresses the following topics: communication protocol, power management, bidirectional charging equipment, safety considerations and regulatory compliance.

The SAE J2847/5 standard defines a communication protocol that allows electric vehicles to communicate with charging infrastructure or other vehicles. This protocol ensures that all participating devices can exchange necessary information related to power transfer, such as power capabilities, state of charge, and safety requirements. V2L functionality allows electric vehicles to discharge electricity from their batteries to power external devices or supply electricity back to the grid. This requires sophisticated power management systems to regulate the flow of electricity and ensure that the vehicle's battery remains within safe operating limits.

Vehicles equipped with V2L capability require charging equipment that supports bidirectional power flow. This equipment may include specialized charging cables, connectors, and control systems designed to facilitate energy transfer in both directions. Safety is paramount in V2L systems. The standard outlines safety protocols to minimize risks associated with bidirectional power transfer, such as overcurrent, overvoltage, and short circuits. Vehicles and charging infrastructure must adhere to these safety requirements to ensure safe operation.

Manufacturers of V2L-enabled vehicles and charging infrastructure must ensure compliance with relevant regulations and standards, including SAE J2847/5. Compliance with standards helps ensure interoperability between different manufacturers' products and promotes widespread adoption of V2L technology. Overall, the V2L functionality based on the SAE J2847/5 standard enables electric vehicles to serve as mobile energy storage units, providing flexibility in energy usage and contributing to the integration of renewable energy sources into the grid.

The donor electric vehicle 110 and the receiver electric vehicle 120 each supports the SAE J1772 standard. SAE J1772 is a standard that defines the physical and electrical interface between electric vehicles and charging equipment. The SAE J1772 standard primarily focuses a standardized connector and communication protocol and typically specifies the following regarding voltage: Alternating Current (AC) Charging Voltage: The standard defines AC charging voltage levels commonly used for electric vehicle charging, such as Level 1 (120 volts AC) and Level 2 (240 volts AC). These voltage levels are used to determine the capabilities and compatibility of charging equipment. Direct Current (DC) Charging Voltage: While not part of the original SAE J1772 standard, subsequent revisions and related standards like SAE J1772-2009 have incorporated provisions for DC fast charging, which can involve higher voltages.

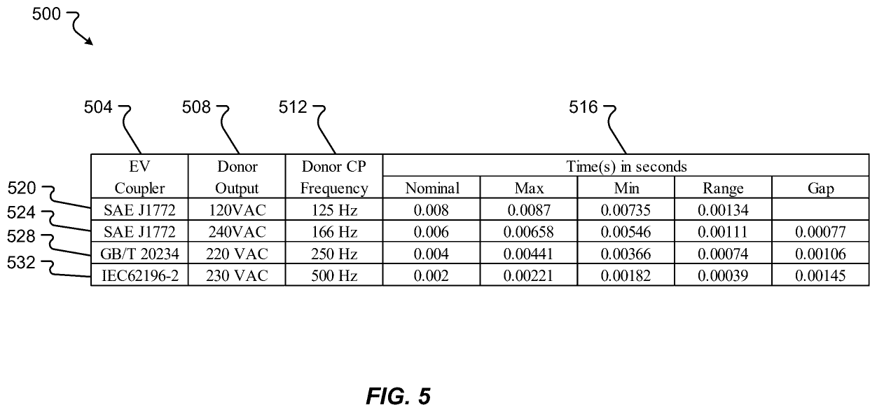

The control pilot (CP) represented by voltage levels (states A, B, C, and F) is used for communication between the donor electric vehicle 110 and the receiver electric vehicle 120. As discussed in greater detail below, the voltage level of the donor electric vehicle 110 is set using a PWM frequency signal that adheres to the SAE J2847/5 standard. A PWM duty cycle represents a current request based on industry standards as discussed in greater detail in FIG. 5.

Referring back to FIG. 3, the control box 274 includes a controller 350, a communicator 354, a user interface 358 and a power supply 362 and is in communication with the cables 278, a donor EVSE connector 310 and a receiver EVSE connector 320. The controller 350 may be implemented as a memory (not shown) for storing data about an algorithm or a program reproducing the algorithm for automatic power negotiation electric V2V charging and a processor (not shown) for performing the automatic power negotiation electric V2V charging using data stored in a memory. In this case, the memory and the processor may be implemented as separate chips. Alternatively, the memory and the processor may be implemented in a single chip. According to an embodiment of the present disclosure, the power supply 362 supplies power to the control box 274.

The controller 350 may be an electronic controller (ECU) for controlling the automatic power negotiation electric V2V charging, and may be any one of a microcomputer, a CPU, and a processor. The communicator 354 may include a chip to perform power line communication (PLC). In addition, the communicator 354 may be connected to the controller 350 to transmit a control signal generated by the controller 350 to the donor electric vehicle 110 and the receiver electric vehicle 120, and specifically transmit to the EVCC 312 and EVCC 332 provided in the donor electric vehicle 110 and the receiver electric vehicle 120, respectively. In addition, the communicator 354 may receive data for the state of charge of the battery 316 from the battery charger 314 and/or the EVCC 312 of the donor vehicle 110 and transmit the data to the controller 350.

The donor EVSE connector 310 is connected to the donor electric vehicle 110 via socket 304 and the receiver EVSE connector 320 is connected to the receiver electric vehicle 120 via socket 324. Although not illustrated, the donor EVSE connector 310 may include a first proximity detection pin, a first ground pin, first CP pin, and a first power pin connected to the socket 304 and the receiver EVSE connector 320 may include a second proximity detection pin, a second ground pin, a second CP pin, and a second power pin connected to the socket 324. In order to connect the donor EVSE connector 310 and the receiver EVSE connector 320, the cables 278 may include a plurality of conductor groups (metals with high conductivity, for example copper, used to reduce transmission losses) constituting a line as a bundle of conductors used surrounded by a protective coating. In addition, the cables 278 may mean a physical wire, but may include the meaning of a data transmission path.

The cables 278 may connect the first proximity pin and the second proximity pin, the first ground pin and the second ground pin, the first CP pin and the second CP pin and the first power pin and the second power pin.

The controller 350 of the control box 274 is connected to the first control pilot pin and the second control pilot pin to control the charging between the donor electric vehicle 110 and the receiver electric vehicle 120. The communicator 354 of the control box 274 receives data for a battery charging state of the donor electric vehicle 110 from the battery charger 314 of the donor electric vehicle 110 and transmits a control signal of the controller 350 to the donor electric vehicle 110 and the receiver electric vehicle 120. That is, the communicator 354 may control the supply of the charging power through the power supply path formed between the first power pin and the second power pin. Moreover, the communicator 354 may receive the battery charge state signals of the donor electric vehicle 111 through the first CP pin and may transmit the power transmission signal generated by the controller 350 to the donor electric vehicle 110 and the receiver electric vehicle 120 through the first CP pin and the second CP pin based on an initial PWM frequency signal setting that is read from memory and processed by a processor which are part of the controller 350. According to an alternative embodiment of the present disclosure, the initial PWM frequency signal setting is read from a removable flash memory and processed by the processor of the controller 350. If the initial PWM frequency signal setting is acceptable by the donor electric vehicle 110, further testing is performed with slightly higher current settings. If the higher PWM frequency signal setting is rejected, the initial PWM frequency signal setting that is stored in memory 362 or in the removable flash memory becomes the maximum setting which reduces testing steps. If there is no initial PWM frequency signal setting (e.g., the first use of the automatic power negotiation electric V2V charging device 270 or the automatic power negotiation electric V2V charging device 270 was used with a different donor electric vehicle), a binary search algorithm is used to determine the maximum setting.

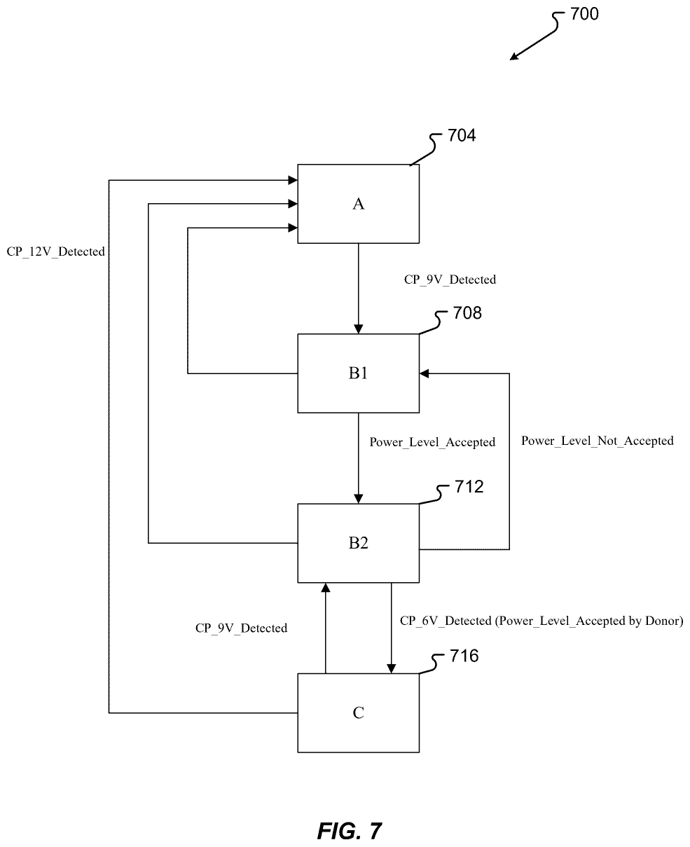

Other components that may be included in the control box 274 include a AC-to-DC converter and a DC-to-AC converter for supplying DC power from the donor electric vehicle 110 to the receiver electric vehicle 120 and supplying AC power from the donor electric vehicle 110 to the receiver electric vehicle 120 and a relay that is configured to be in the closed positioned when the donor electric vehicle 110 and the receiver electric vehicle 120 are in state C (e.g., ready to charge state) as discussed in greater detail below in FIG. 7.

The user interface 358 may include a display unit (not shown) indicating the charge state or series of procedures for automatic power negotiation electric V2V charging.

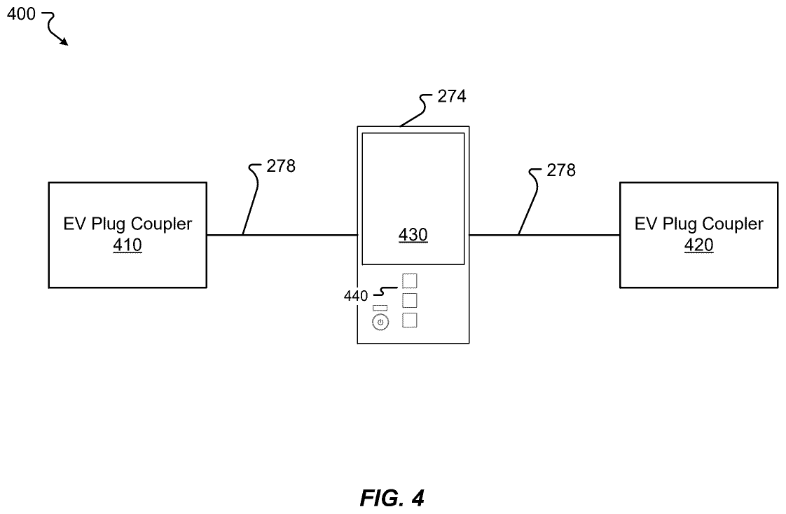

FIG. 4 is a diagram of an example automatic power negotiation electric V2V charging device 400 in accordance with embodiments of the present disclosure. The automatic power negotiation electric V2V charging device 400 generally includes a control box 274, cables 278, donor EV plug coupler 410 and receiver EV plug coupler 420. Donor EV plug coupler 410 and receiver EV plug coupler 420 each includes electronics and provides communication and switching functionality. The donor EV plug coupler 410 and the receiver EV plug coupler 420 may be a male connector, a female connector or otherwise. The control box 274 further includes a display 430 and a keypad 440 to enable a user to enter commands to the controller 350 (e.g., requesting a particular data transfer or information) and/or to respond to prompts on the display 430 generated by software or firmware related to automatic power negotiation electric V2V charging. The display 430 may be a touch screen, enabling a user to communicate with the controller 350. In this case, the keypad 440 may not be required.

The control box 274 includes an auxiliary power supply that provides a bias voltage and current to all of the circuit elements provided therein. A relay is provided to transfer power from the donor electric vehicle 110 to the receiver electric vehicle 120. As discussed above, a control algorithm is provided therein to perform automatic power negotiation.

According to embodiments of the present disclosure, the automatic power negotiation electric V2V charging device provides a single electric V2V charging cable that simplifies the charging process for users. Users do not have to carry separate devices of cables for electric V2V charging. Moreover, fewer components mean a lower chance of technical issues and reduced complexity in troubleshoots problems. With the single electric V2V charging cable, the incompatibility issues between EVSE and V2L devices are eliminated. Therefore, users are confident that the single electric V2V charging cable works seamlessly with compatible electric vehicles. The single electric V2V charging cable simplifies a user's experience by reducing the risk of user errors during setup operations (e.g., plug and play functionality is straight forward). Moreover, the single electric V2V charging cable with standardized connectors can enhance safety. Thus, there is no need to manage multiple cables and connectors which reduces the risk of improper connections or cable damage. Furthermore, in emergency situations where electric V2V charging is required, the single electric V2V charging cable can be deployed more quickly and efficiently than setting up separate EVSE and V2L devices.

FIG. 5 is an example table 500 of a donor control pilot frequency and tolerance summary for electric V2V charging according to conventional standards. Table 500 includes the following parameters: Electric Vehicle (EV) Coupler 504, the Donor Output 508, the Donor Control Pilot (CP) Frequency 512 and the Time(s) 516. Table 500 provides three (3) EV Coupler standards: SAE standard SAE J2847/5; Chinese national standard GB/T 20234; and international standard IEC 62196-2 that specifies the requirements for connectors, cable assemblies, and communication protocols for charging EVs. According to the conventional standards, these values for the donor output 508 and the Donor CP frequency 512 are fixed values and do not change.

Therefore, as illustrated in table 500, for the SAE J2847/5 standard, a donor output of 120 VAC requires the donor CP to have a frequency of 125 Hz at row 520 while a donor output of 240 VAC requires the donor CP to have a frequency of 166 Hz at row 524. For the GB/T 20234 standard at row 528, a donor output of 220 VAC requires the donor CP to have a frequency of 250 Hz and for the IEC 62196-2 standard at row 532, a donor output of 230 VAC requires the donor CP to have a frequency of 500 Hz. The Time(s) 516 represent a nominal value, a maximum value, a minimum value, a range value and a gap value. The time values are measured in seconds. The nominal values are determined by taking the reciprocal of the donor output 508 (e.g., the CP PWM frequency). The maximum and minimum values are the times needed to identify the donor output. The range value is the difference between the maximum value and the minimum value and the gap value is a value that is intended to ensure the CP frequency does not overlap with each other even with the tolerance.

For example, at row 520 (SAE J1772 at 120 VAC/125 Hz), the nominal value is 0.008 s the maximum value is 0.00870 s, the minimum value is 0.00735 s and the range value is 0.00134 s. At row 524 (SAE J1772 at 240 VAC/166 Hz), the nominal value is 0.006 s the maximum value is 0.00658 s, the minimum value is 0.00546 s and the range value is 0.00111 s. At row 528 (GB/T 20234 at 220 VAC/250 Hz), the nominal value is 0.004 s, the maximum value is 0.00441 s, the minimum value is 0.00366 s and the range value is 0.00074 s. At row 532 (IEC 62196-2 at 230 VAC/500 Hz), the nominal value is 0.002 s, the maximum value is 0.00221 s, the minimum value is 0.00182 s and the range value is 0.00039 s.

At row 520, since 125 Hz is base frequency there is no gap value. At row 524, the gap value for 166 Hz is calculated as the minimum value at 125 Hz minus the maximum value at 166 Hz, resulting in (0.00735−0.00658) =0.00077 s. At row 528, the gap value for 250 Hz is calculated as the minimum value at 166 Hz minus the maximum value at 250 Hz, resulting in (0.00546−0.00441)=0.00105 s. At row 532, the gap value for 500 Hz is calculated as the minimum value at 250 Hz minus the maximum value at 500 Hz, resulting in (0.00546−0.00441) =0.00145 s. Referring back to row 524, the minimum tolerance for a donor output for 166 Hz is 152 Hz (e.g., the corresponding 0.00658 s maximum value) and the maximum tolerance for the donor output for 166 Hz is 183 Hz (e.g., the corresponding 0.00546 s minimum value).

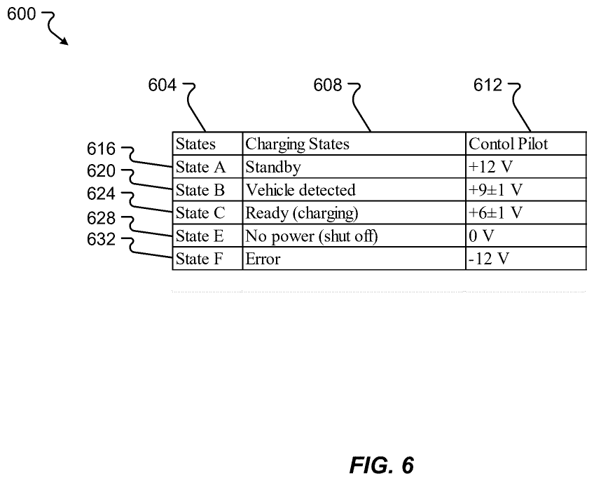

FIG. 6 is an example table 600 of control pilot states for electric V2V charging. Table 600 includes the following parameters: States 604, Charging States 608 and Control Pilot 612. State A 616 is in a “Standby” charging state when the control pilot is positive 12V (+12V). State B 620 is defined to be in a “Vehicle Detected” charging state when the control pilot is positive 9V plus or minus 1V (+9V±1V). State C 624 is defined to be in a “Ready-Charging” charging state when the control pilot is positive 6V plus or minus 1V (+6V±1V). State E 628 is defined to be in a “No Power (Shut Off)” charging state when the control pilot is 0V. State F is defined to be in an “Error” charging state when the control pilot is minus 12V (−12V).

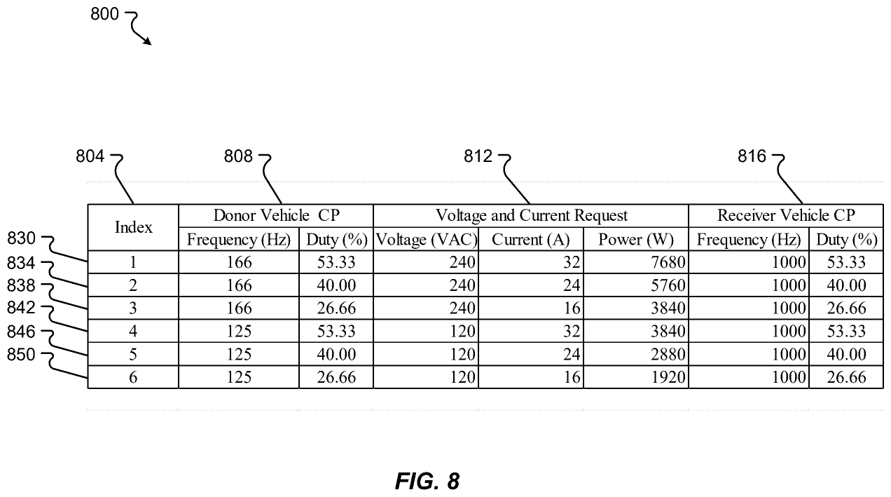

FIG. 7 is a diagram illustrating an example donor control pilot state machine 700 for automatic power negotiation electric V2V charging in accordance with embodiments of the present disclosure. The donor control pilot state machine 700 includes state A 704, state B1 708, state B2 712 and state C 716. At state A 704, the donor electric vehicle is in a standby state with the CP signal detected at 12V. At state B1 708, the automatic power negotiation electric V2V charging device 270 detects the donor electric vehicle 110 (e.g., plugging the automatic power negotiation electric V2V charging device 270 into the donor electric vehicle 110). The CP signal is pulled down and detected at 9V. As discussed in greater detail below with respect to FIG. 8, during the automatic power negotiation process to determine an acceptable power level for the donor electric vehicle 110, if the donor electric vehicle 110 accepts a power level, then the donor control pilot state machine 700 proceeds to state B2 712. At this point, the CP signal is pulled down and detected at 6V. If the donor electric vehicle 110 does not accept the power level, then the donor control pilot state machine 700 returns to state B1 708 until a power level is accepted. At this point, the CP signal is still detected at 9V. At state C 716, the donor electric vehicle 110 is charging the receiver electric vehicle 120 with the CP signal detected at 6V. If the CP signal is detected at 12V at States B1 708, B2 712 or C 716 (e.g., the automatic power negotiation electric V2V charging device 270 is unplugged from the donor electric vehicle 110), the donor control pilot state machine 700 returns to state A 704.

If the CP signal is detected at 9V at state C 716 (e.g., the donor electric vehicle 110 is unable to provide the accepted power level to the receiver electric vehicle 120), the donor control pilot state machine 700 returns to state B2 712 for further automatic power negotiation, for example.

FIG. 8 is an example power level table 800 for an automatic power negotiation electric V2V charging system in accordance with embodiments of the present disclosure. The example power level table 800 includes the following parameters: Index numbers 804, Donor CP values for Frequency and Duty Cycle 808, Power Request values in voltage, current and power 812 and Receiver CP values for Frequency and Duty Cycle 816.

For example, index number 1 830 includes a donor CP value of 166 Hz at a duty cycle of 53.33%, a power request value of 240 VAC, 32 A and 7680 W and a receiver CP value of 1000 Hz at a duty cycle of 55.33%. Index number 2 834 includes a donor CP value of 166 Hz at a duty cycle of 40.00%, a power request value of 240 VAC, 24 A and 5760 W and a receiver CP value of 1000 Hz at a duty cycle of 40.00%. Index number 3 838 includes a donor CP value of 166 Hz at a duty cycle of 26.66%, a power request value of 240 VAC, 16 A and 3840 W and a receiver CP value of 1000 Hz at a duty cycle of 26.66%. Index number 4 842 includes a donor CP value of 125 Hz at a duty cycle of 53.33%, a power request value of 120 VAC, 32 A and 3840 W and a receiver CP value of 1000 Hz at a duty cycle of 53.33%. Index number 5 846 includes a donor CP value of 125 Hz at a duty cycle of 40.00%, a power request value of 120 VAC, 24 A and 2880 W and a receiver CP value of 1000 Hz at a duty cycle of 40.00%. Index number 6 850 includes a donor CP value of 125 Hz at a duty cycle of 26.66%, a power request value of 120 VAC, 16 A and 1920 W and a receiver CP value of 1000 Hz at a duty cycle of 26.66%.

Taking index number 2 834 for example, for a given power request of 5760 W (e.g., 240 VAC at a current of 24 A), the automatic power negotiation electric V2V charging device 270 generates 166 Hz at a duty cycle of 40.00% through the donor CP to negotiate with the donor electric vehicle 110 at the power request of 5760 W. If the donor vehicle 110 accepts this power request of 5760 W, then the automatic power negotiation electric V2V charging device 270 generates 1000 Hz at a duty cycle of 40.00% through the receiver CP of the receiver electric vehicle 120 for power transfer at the power request of 5760 W.

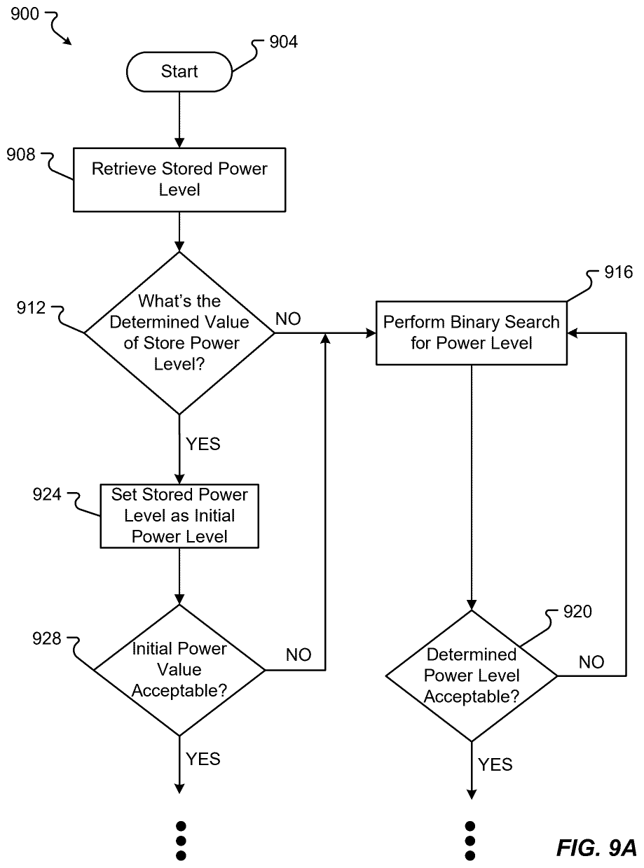

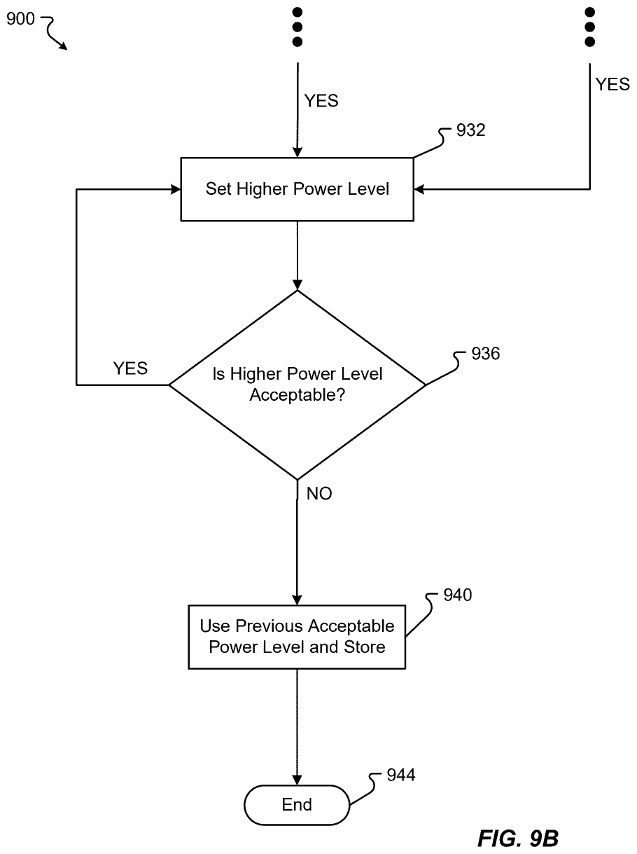

If, however, the donor electric vehicle 112 can supply more power to the receiver electric vehicle 110 than the requested 5760 W, another power request is sent to the donor electric vehicle 110 (e.g., index number 1 830 with a voltage of 240 VAC and an increase in current to 32 A with a power of 7680 W). The automatic power negotiation electric V2V charging device 270 generates 166 Hz at a duty cycle of 53.33% through the donor CP to negotiate with the donor electric vehicle 110 at the power request of 7680 W. This automatic power negotiation process continues until a maximum power setting for the donor electric vehicle 110 is reached as discussed in greater detail in FIG. 9.

FIGS. 9a and 9b illustrate a flowchart of an example method 900 for automatic power negotiation for an electric V2V charging in accordance with embodiments of the present disclosure. While a general order of the steps of method 900 is shown in FIGS. 9a and 9b, method 900 can include more or fewer steps or can arrange the order of the step differently than those shown in FIGS. 9a and 9b. Further, two or more steps may be combined in one step. Generally, the method 900 starts at START operation at step 904 and ends with an END operation at step 944. The method 900 can be executed as a set of computer-executable instructions executed by a computer system (e.g., the controller 350) and encoded or stored on a computer readable medium (e.g., memory). Hereinafter, the method 900 shall be explained with reference to the systems, components, modules, applications, software, data structures, user interfaces, etc. described in conjunction with FIGS. 1-8.

As illustrated in FIG. 9a, method 900 begins at step 904 and proceeds to step 908, where the controller 350 of the automatic power negotiation electric V2V charging device 270 retrieves a stored power level for the donor electric vehicle 110. The power level can be stored internally or stored on a removable storage device. After retrieving the stored power level for the donor electric vehicle 110 at step 908, method 900 proceeds to decision step 912, where the controller 350 of the automatic power negotiation electric V2V charging device 270 determines the value of the stored power level.

According to embodiments of the present disclosure, determining the value of the stored power level means determining if the stored power level has a non-zero value. If the stored power level is determined to have a non-zero value (YES) at decision step 912, method 900 proceeds to step 924 where the controller 350 of the automatic power negotiation electric V2V charging device 270 sets the stored power level as the initial power level. According to embodiments of the present disclosure, the stored power level may be a value listed in Table 800 illustrated in FIG. 8. For example, the stored power level may be 3840 W (e.g., 120 VAC at 32 A) as identified with index number 4 842 in Table 800.

After the stored power level is set as the initial power level at step 924, method 900 proceeds to decision step 928, where the controller 350 of the automatic power negotiation electric V2V charging device 270 determines if the initial power level is acceptable by the donor electric vehicle 110. If the initial power level is acceptable by the donor electric vehicle 110 (YES) at decision step 928, method 900 proceeds to step 932 as illustrated in FIG. 9b, where the controller 350 of the automatic power negotiation electric V2V charging device 270 sets a higher power level for the accepted initial power level.

If the stored power level is determined to not have a non-zero value (NO) at decision step 912, method 900 proceeds to step 916, where the controller 350 of the automatic power negotiation electric V2V charging device 270 performs a binary search for the power level. A binary search is an efficient algorithm for finding an item from a sorted list of items. It works by repeatedly dividing in half the portion of the list that could contain the item, until you've narrowed down the possible locations to just one. The steps of the binary search are: (1) initialize, (2) find the middle element, (3) compare, (4) update search interval and (5) repeat. For the initialize step, the entire stored array is provided. For the find the middle element step, the middle element of the sorted array is determined. For the compare step, the middle element is compared with a target value. For the update search interval step, if the middle element is equal to the target value, the search is successful, and the index is returned. If the middle element is greater than the target value, the search continues in the lower half of the sorted array. Otherwise, if the middle element is less than the target value, the search continues in the upper half of the array. For the repeat step, steps 2-4 are repeated until the target value is found or the search interval is empty.

According to an example embodiment of the present disclosure, the power level is determined using the binary search on the power level table 800 of FIG. 8. First, the binary search identifies the middle of the power level table 800. The middle of the power level table 800 would be either index number 3 838 or index number 4 842. Index number 3 838 or index number 4 842 is compared with a target value and an update search is performed to determine if either index number 3 838 or index number 4 842 is equal to the target value, greater than the target value or less than the target value until the target value is identified.

After the power level has been identified using the binary search at step 916, method 900 proceeds to decision step 920, where the controller 350 of the automatic power negotiation electric V2V charging device 270 determines if the identified power level using the binary search is acceptable by the donor electric vehicle 110. If the determined power level is not acceptable (NO) by the donor electric vehicle 110 at decision step 920, method 900 returns to step 916 to identify a power level using the binary search.

If the determined power level is acceptable (YES) by the donor electric vehicle 110 at decision step 920, method 900 proceeds to step 932 as illustrated in FIG. 9b, where the controller 350 of the automatic power negotiation electric V2V charging device 270 sets a higher power level for the accepted determined power level.

If the initial power level is not acceptable by the donor electric vehicle 110 (NO) at decision step 928, method 900 proceeds to step 916, where the controller 350 of the automatic power negotiation electric V2V charging device 270 performs a binary search to determine a power level. After a power level has been determined using the binary search at step 916, method 900 proceeds to decision step 920, where the controller 350 of the automatic power negotiation electric V2V charging device 270 determines if the determined power level using the binary search is acceptable by the donor electric vehicle 110. If the determined power level is not acceptable (NO) by the donor electric vehicle 110 at decision step 920, method 900 returns to step 916 to determine a power level using the binary search. If the determined power level is acceptable (YES) by the donor electric vehicle 110 at decision step 920, method 900 proceeds to step 932 where the controller 350 of the automatic power negotiation electric V2V charging device 270 sets a higher power level for the accepted determined power level.

After setting the higher power level for the accepted initial power level or the accepted determined power level at step 932 as illustrated in FIG. 9b, method 900 proceeds to decision step 936, where the controller of the automatic power negotiation electric V2V charging device 270 determines if the higher power level is acceptable by the donor electric vehicle 110. According to an example embodiment of the present disclosure, setting a higher power level for the accepted initial power level or the accepted determined power level includes increasing the current and keeping the voltage constant, increasing the current and increasing the voltage, increasing the voltage and keeping the current constant, increasing the voltage and increasing the current or increasing the voltage and decreasing the current. Take for example the previous power value of 3840W identified as index number 4 842. Setting a higher power level may include increasing the voltage from 120 VAC to 240 VAC and decreasing the current from 32 A to 16 A as indicated at index number 3 838. With this increase power level, the automatic power negotiation electric V2V charging device 270 generates 166 Hz at a duty cycle of 26.66% through the donor CP to negotiate with the donor electric vehicle 110 at the power request of 3840 W.

If the higher power level is acceptable for the accepted initial power level or the accepted determined power level (YES) at decision step 936, method 900 returns to step 932 where the controller 350 of the automatic power negotiation electric V2V charging device 270 sets another higher power level for the accepted initial power level or the accepted determined power level. According to an example embodiment of the present disclosure, if the higher power level identified at index number 3 from Table 800 is acceptable to the donor electric vehicle 110, then setting another higher power level may include maintaining the voltage at 240 VAC and increasing the current from 16 A to 24 A as indicated at index number 2 834. With this increase power level, the automatic power negotiation electric V2V charging device 270 generates 166 Hz at a duty cycle of 40.00% through the donor CP to negotiate with the donor electric vehicle 110 at the increased power request of 5760 W.

If the higher power level is not acceptable for the accepted initial power level or the accepted determined power level (NO) at decision step 936, method 900 proceeds to step 940 where the controller 350 of the automatic power negotiation electric V2V charging device 270 uses the previously accepted power level and stores the value in memory. Therefore, if the power level of 5760 W is not accepted by the donor electric vehicle 110, the previous power level of 3840 W would be used and stored in memory.

After using the previously accepted power level for transferring an electric charge from the donor electric vehicle 110 to the receiver electric vehicle 112 and storing the previously accepted power level in memory at step 940, method 900 ends with END operation at step 944.

Any of the steps, functions, and operations discussed herein can be performed continuously and automatically.

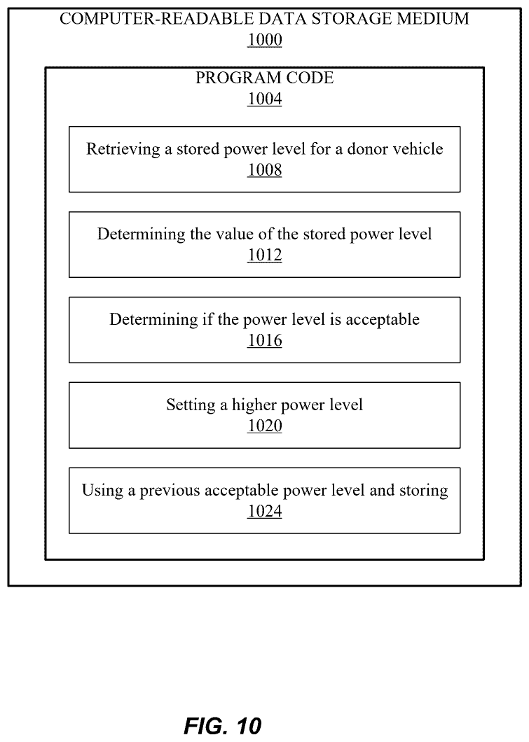

FIG. 10 shows an example non-transitory computer-readable data storage medium 1000. The computer-readable data storage medium stores program code 1004 executable by a processor, such as processor 350 to perform processing. The processing may be a processor of a system, like that of FIG. 3. The processing is consistent with but more general than the method of FIG. 9. The processing includes retrieving a stored power level for a donor electric vehicle (1008), determining the value of the stored power level (1012), determining if the power level is acceptable (1016), setting a higher power level (1020) and using previous acceptable power level and storing (1024).

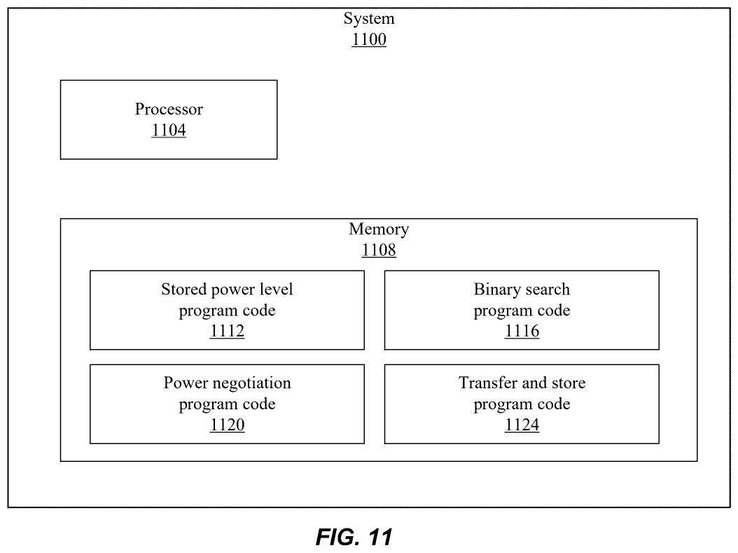

FIG. 11 shows an example system 1100. The system 1100 is consistent with but more general than the system of FIG. 3. The system 1100 includes a processor 1104, and a memory 1108 storing program code executable by the processor 1104. The program code includes stored power level program code 1112 to store the last power level used by the donor vehicle. If the last power level used the donor vehicle has a zero value, this could mean the first use of the system.

The program code also includes binary search program code 1116. The binary search program code 1116 is used to determine a power level when a zero value is provided by the stored power level. The program code further includes power negotiation program code 1120 and transfer and store program code 1124. The power negotiation program code 1120 is used to determine the highest power level in which the donor vehicle can operate. The transfer and store program code 1124 is used to transfer an electric charge from a donor electric vehicle to a receiver electric vehicle based on the negotiated highest power level and store that value.

The example methods, systems, and devices of this disclosure have been described in relation charging between electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the embodiments illustrated herein show the various components in a single device, certain components can be in one or multiple devices. Thus, it should be appreciated that the components can be combined into one or more devices.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A method for automatic power negotiation for electric vehicle-to-vehicle charge transfer, comprising:
connecting a donor electric vehicle to a receiver electric vehicle via a charging cable of a charging cable system;
receiving from a control box of the charging cable system, an initial power setting for the donor electric vehicle;
determining if the initial power setting has a non-zero value;
if the initial power setting has a non-zero value, determining if the initial power setting is acceptable by the donor electric vehicle;
if the initial power setting is acceptable by the donor electric vehicle, repeatedly increasing the initial power setting to a higher power setting until a maximum power setting is determined; and
transferring an electric charge from the donor electric vehicle to the receiver electric vehicle along the charging cable based on the maximum power setting.

2. The method of claim 1, wherein the donor electric vehicle is configured to transmit to the receiver electric vehicle, via the charging cable, an indication of the maximum power setting.

3. The method of claim 1, wherein if the initial power setting is not acceptable by the donor electric vehicle, assigning the initial power setting as the maximum power setting.

4. The method of claim 1, further comprising storing the maximum power setting in the control box.

5. The method of claim 1, wherein if the initial power setting is determined not to have a non-zero value, determining a power setting using a binary search.

6. The method of claim 5, further comprising:
determining if the power setting determined using the binary search is acceptable by the donor electric vehicle;
if the power setting determined using the binary search is acceptable by the donor electric vehicle, repeatedly increasing the power setting determined using the binary search to a higher power setting until the maximum power setting is determined; and
transferring the electric charge from the donor electric vehicle to the receiver electric vehicle along the charging cable based on the maximum power setting.

7. The method of claim 1, wherein repeatedly increasing the initial power setting to a higher power setting includes increasing a current value and keeping a voltage value constant, increasing the current value and increasing the voltage value, increasing the voltage value and keeping the current value constant, increasing the voltage value and increasing the current value or increasing the voltage value and decreasing the current value.

8. The method of claim 1, wherein the charging cable system includes electric vehicle supply equipment (EVSE) connectors to connect the donor electric vehicle to the receiver electric vehicle.

9. A system for automatic power negotiation for electric vehicle-to-vehicle charge transfer, comprising:
a charging cable configured to connect a donor electric vehicle to a receiver electric vehicle; and
a control box configured to:
retrieve an initial power setting for the donor electric vehicle;
determine if the initial power setting has a non-zero value;
if the initial power setting has a non-zero value, determine if the initial power setting is acceptable by the donor electric vehicle;
if the initial power setting is acceptable by the donor electric vehicle, repeatedly increase the initial power setting to a higher power setting until a maximum power setting is determined; and
transfer an electric charge from the donor electric vehicle to the receiver electric vehicle along the charging cable based on the maximum power setting.

10. The system of claim 9, wherein the donor electric vehicle is configured to transmit to the receiver electric vehicle, via the charging cable, an indication of the maximum power setting.

11. The system of claim 9, wherein if the initial power setting is not acceptable by the donor electric vehicle, the control box is further configured to assign the initial power setting as the maximum power setting.

12. The system of claim 9, wherein the control box is further configured to store the maximum power setting in the control box.

13. The system of claim 9, wherein if the initial power setting is determined not to have a non-zero value, the control box is further configured to determine a power setting using a binary search.

14. The system of claim 13, wherein the control box is further configured to:
determine if the power setting determined using the binary search is acceptable by the donor electric vehicle;
if the power setting determined using the binary search is acceptable by the donor electric vehicle, repeatedly increase the power setting determined using the binary search to a higher power setting until the maximum power setting is determined; and
transfer the electric charge from the donor electric vehicle to the receiver electric vehicle along the charging cable based on the maximum power setting.

15. The system of claim 9, wherein repeatedly increase the initial power setting to a higher power setting includes increases a current value and keep a voltage value constant, increase the current value and increase the voltage value, increase the voltage value and keep the current value constant, increase the voltage value and increase the current value or increase the voltage value and decrease the current value.

16. The system according to claim 15, wherein the charging cable includes electric vehicle supply equipment (EVSE) connectors for connecting the donor electric vehicle and the receiver electric vehicle.

17. A control box, comprising:
one or more processors configured to:
retrieve an initial power setting for a donor electric vehicle;
determine if the initial power setting has a non-zero value;
if the initial power setting has a non-zero value, determine if the initial power setting is acceptable by the donor electric vehicle;
if the initial power setting is acceptable by the donor electric vehicle, repeatedly increase the initial power setting to a higher power setting until a maximum power setting is determined; and
transfer an electric charge from the donor electric vehicle to a receiver electric vehicle along a charging cable connecting the donor electric vehicle and the receiver electric vehicle based on the maximum power setting.

18. The control box of claim 17, wherein if the initial power setting is determined not to have a non-zero value, the control box is further configured to determine a power setting using a binary search.

19. The control box of claim 18, wherein the control box is further configured to:
determine if the power setting determined using the binary search is acceptable by the donor electric vehicle;
if the power setting determined using the binary search is acceptable by the donor electric vehicle, repeatedly increase the power setting determined using the binary search to a higher power setting until the maximum power setting is determined; and
transfer the electric charge from the donor electric vehicle to the receiver electric vehicle along the charging cable based on the maximum power setting.

20. The control box of claim 17, wherein repeatedly increase the initial power setting to a higher power setting includes increases a current value and keep a voltage value constant, increase the current value and increase the voltage value, increase the voltage value and keep the current value constant, increase the voltage value and increase the current value or increase the voltage value and decrease the current value.
